(19) United States
(12) Patent Application Publication
(10) Pub. No.: US 2010/0064606 A1
(43) Pub. Date: Mar. 18, 2010

(54) Storm Shutter System

(76) Inventors: Ravi K. Devalapura, New Albany, OH (US); Thomas P. Hager, Columbus, OH (US)

Correspondence Address: OWENS CORNING, 2790 COLUMBUS ROAD, GRANVILLE, OH, 43023, US

(21) Appl. No.: 12/233,134

(22) Filed: Sep. 18, 2008

(51) Int. Cl. E06B 9/02; E06B 3/26

(52) U.S. Cl. 52/202

(57) ABSTRACT

A storm-shutter assembly includes a panel having an opening, a window held in the opening and a seal provided along a perimeter of the panel.

This application claims the benefit of U.S. provisional patent application Ser. No. 60/994,047 filed on 17 Sep. 2007.

### TECHNICAL FIELD AND INDUSTRIAL APPLICABILITY OF THE INVENTION

The present invention relates generally to weather shielding for buildings and, more particularly to a storm shutter system for protecting windows from damage caused by storms such as hurricanes.

### BACKGROUND OF THE INVENTION

Storm shutter systems for protecting windows from damage resulting from high winds and precipitation such as associated with hurricanes are well known in the art. U.S. Pat. No. 6,334,282 to Wood and Published U.S. Patent Applications 2006/0010792 to Biggers, 2006/0179737 to Trundle and 2006/0179735 to McNelis are representative of this art.

The present invention relates to a storm-shutter system that is relatively inexpensive to produce, is simple to install/remove, is reusable and provides a long service life.

### SUMMARY OF THE INVENTION

In accordance with the purposes of the present invention as described herein, a storm-shutter assembly is provided. The storm-shutter assembly comprises a panel including an opening, a window held in that opening and a seal provided along a perimeter of the panel. The panel may be constructed from a fiber-reinforced plastic. More specifically, the panel may be constructed from a composite material including (a) a matrix binder selected from a group consisting of polyester, vinyl ester, epoxy, polyurethane, polycarbonate, polyamide, polypropylene, polyvinyl chloride and mixtures thereof and (b) a reinforcement element selected from a group consisting of glass fibers, carbon fibers, aramid fibers, polypropylene fibers, natural fibers and mixtures thereof.

The window may be made from a translucent, shatterproof material or a transparent, shatterproof material. More specifically, the window is made from a material selected from a group consisting of polycarbonate, reinforced polysulfone, safety glass, bullet proof glass, glass and mixtures thereof.

The seal is made from a material selected from a group consisting of rubber, silicone, plastic, vinyl, foam and mixtures thereof. When the storm-shutter assembly is properly mounted on a building spanning a window, the seal seals against the building preventing precipitation from reaching that window.

The storm-shutter assembly further includes at least one fastener to secure the assembly to a building over the window to be protected. That fastener may take the form of a wing nut.

In one possible embodiment of the storm-shutter assembly, the assembly further includes a first mounting bracket that is secured to the building and defines a receiver for holding a first side of the panel. The first side includes a first front margin, a first rear margin and a first edge extending between the first front margin and the first rear margin. The seal includes a first section that covers the first front and rear margins and first edge. The first section of the seal is received and held in the receiver. The panel further includes a second side, a third side and a fourth side. A series of fasteners are provided along the second, third and fourth sides to secure the panel to the building with the seal tightly engaging the building.

In accordance with yet another embodiment of the present invention the storm-shutter assembly includes the first mounting bracket as discussed above and a second mounting bracket that is secured to the building and defines a first mounting flange for holding a second side of the panel. The second side is opposite the first side. The second side of the panel includes a second mounting flange that mates with the first mounting flange. The storm shutter assembly of this embodiment includes a third side and a fourth side along with a series of fasteners that are provided along the third and fourth sides to secure the panel to the building with the seal tightly engaging the building. Still further, the seal includes a second section provided along the second mounting flange that engages and seals against the first mounting flange.

In the following description there is shown and described several preferred embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a perspective view of the storm-shutter assembly of the present invention;

FIG. 2 is a front plan view showing the mounting of the storm-shutter assembly of FIG. 1 over a window on a building;

FIG. 3 is a side elevational view of the FIG. 2 embodiment;

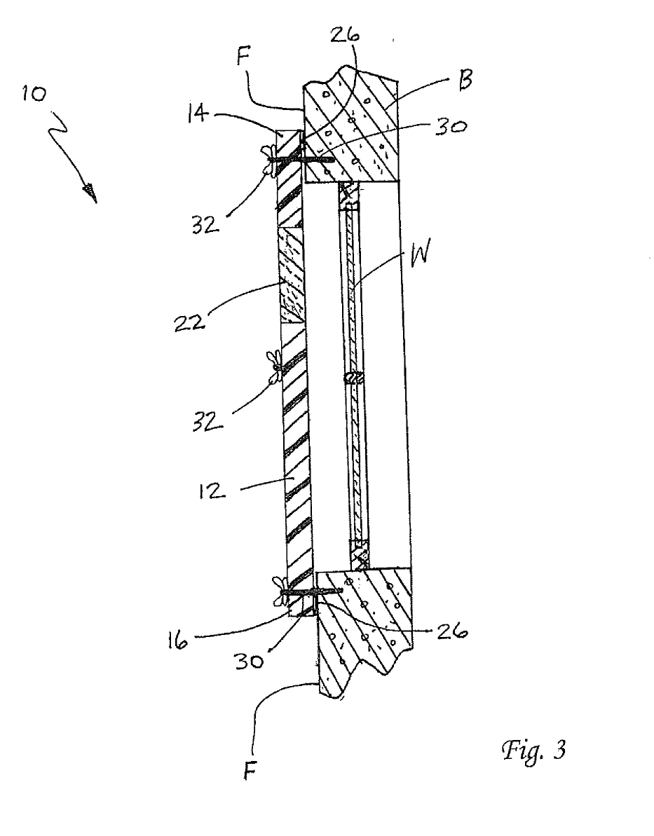

FIG. 4 is a front plan view of a first alternative embodiment of the present invention mounted on a building over a window;

FIG. 5 is a side elevational view of the FIG. 4 embodiment;

FIG. 6 is a front plan view of a second alternative embodiment of the present invention shown on a building over a window;

FIG. 7 is a side elevational view of the FIG. 6 embodiment;

FIG. 8 is a front elevational view of still another embodiment of the storm shutter assembly of the present invention;

FIG. 9 is a detailed side elevational view of the storm shutter assembly of FIG. 8 showing how the slot at the bottom of the shutter is received over and held in place by the head of a stud-head mounting bolt; and

FIG. 10 is a side elevational view showing yet another embodiment of the storm shutter assembly mounted on a building over a window.

Reference will now be made in detail to the present preferred embodiments of this invention, examples of which are illustrated in the accompanying drawings.

### DETAILED DESCRIPTION OF THE PREFERRED EMBODIMENTS OF THE INVENTION

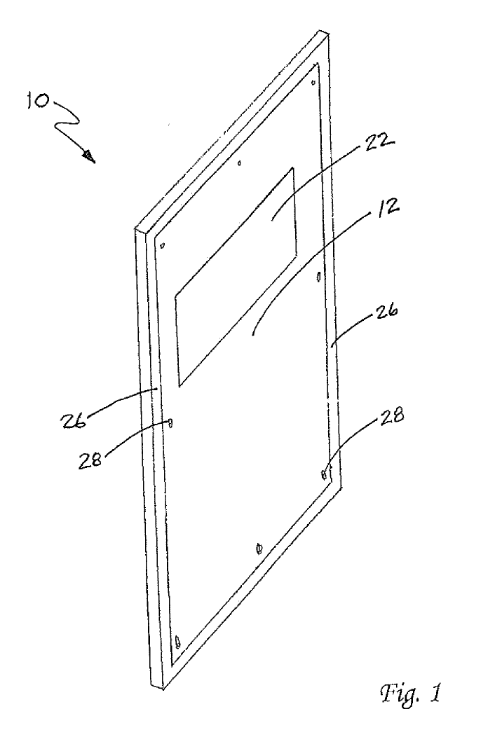

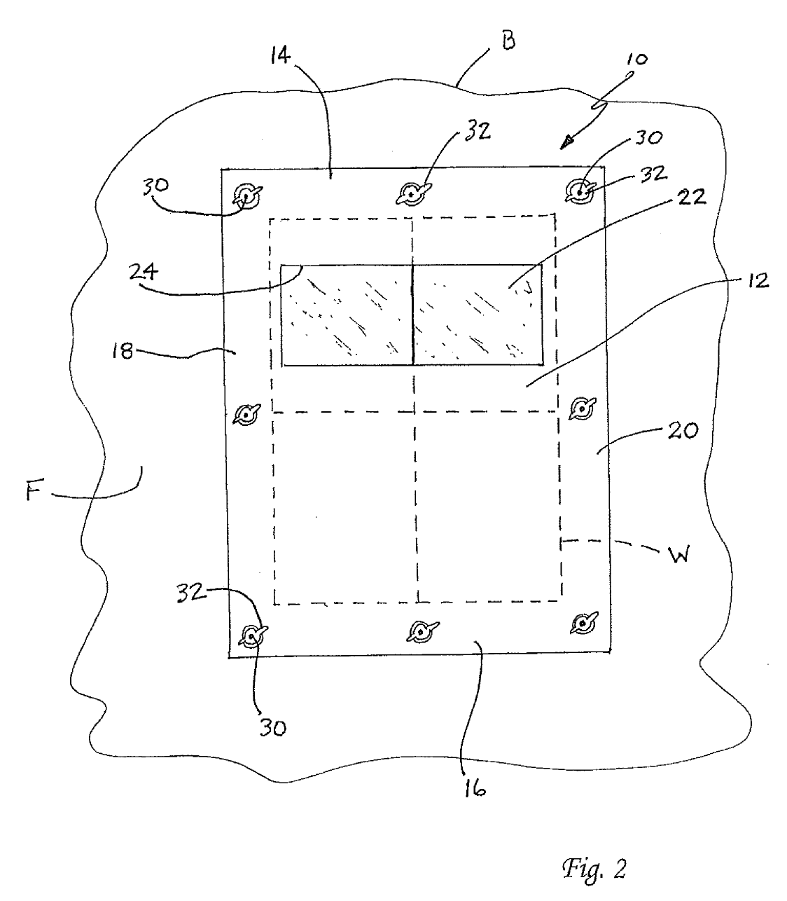

As illustrated in FIGS. 1 and 2, the present invention relates to a storm-shutter assembly 10. The storm-shutter assembly 10 includes a panel 12 having a first side 14, second side 16, third side 18 and fourth side 20. A transparent or translucent window 22 is provided in an opening 24 provided in the panel 12. A seal 26 is provided along or around a perimeter of the panel 12.

The panel 12 may be constructed from a fiber-reinforced plastic. More specifically, the panel 12 may be constructed from a composite material including (a) a matrix binder selected from a group consisting of polyester, vinyl ester, epoxy, polyurethane, polycarbonate, polyamide, polypropylene, polyvinyl chloride and mixtures thereof and (b) a reinforcement element selected from a group consisting of glass fibers, carbon fibers, aramid fibers, polypropylene fibers, natural fibers (eg. Hemp, kenaf, jute, sisal, cellulose) and mixtures thereof. The matrix binder may take the form of a powder or fibers.

Where the reinforcement element is glass fibers, the fibers may be continuous or staple fibers having a length of between about 3 and about 75 mm. The glass fibers may have a diameter of between about 6 and about 35 μm. Substantially any type of fiberglass may be utilized but typically the fibers would be made from E-glass or low boron glass such as sold by Owens Corning under the trademark ADVANTEX.

The window 22 is preferably made from a translucent or transparent shatterproof material. More specifically, the window may be made from a material selected from a group consisting of polycarbonate, reinforced polysulfone, glass reinforced polysulfone, glass reinforced polyester, glass reinforced epoxy, safety glass, bullet-proof glass, glass and mixtures thereof.

The seal 26 is preferably made from a material selected from group consisting of rubber, silicone, plastic, vinyl, foam and mixtures thereof. The seal must be capable of providing a tight weatherproof seal with the façade of a building while also providing a long service life.

As best illustrated in FIG. 2, the storm-shutter assembly 10 is mounted to a building B so as to span and protect a building window W (or doorway) in the event of a storm. More specifically, a series of apertures 28 (circular, oblong or other appropriate shape) are provided around the perimeter or margin of the panel 12. These apertures 28 receive a series of threaded anchors 30 that are secured to and project from the façade F of the building B. As illustrated the threaded anchors 30 are of sufficient length to extend past the front face of the panel 12 when the panel is positioned on the anchors. A series of fasteners, in the form of wing nuts 32, are then tightened down against the panel 12 on the threaded anchors 30. If desired, a fender washer (not shown) may be provided between each of the wing nuts 32 and the panel 12 in order to provide a larger engagement area and add strength. As the wing nuts 32 are tightened, the seal 26 on the panel 12 tightly seals against the façade F of the building B completely around the window W along the first, second, third and fourth sides 14, 16, 18, 20 of the panel 12. In this way the panel 12 prevents moisture and precipitation from reaching the window W. Simultaneously, the window 22 in the panel 12 allows light through the panel 12 to reach the interior of the building B through the window W. As a consequence, the occupants of the building receive natural light and do not feel as if they are living in a cave when the storm-shutter assembly 10 is positioned over the window W.

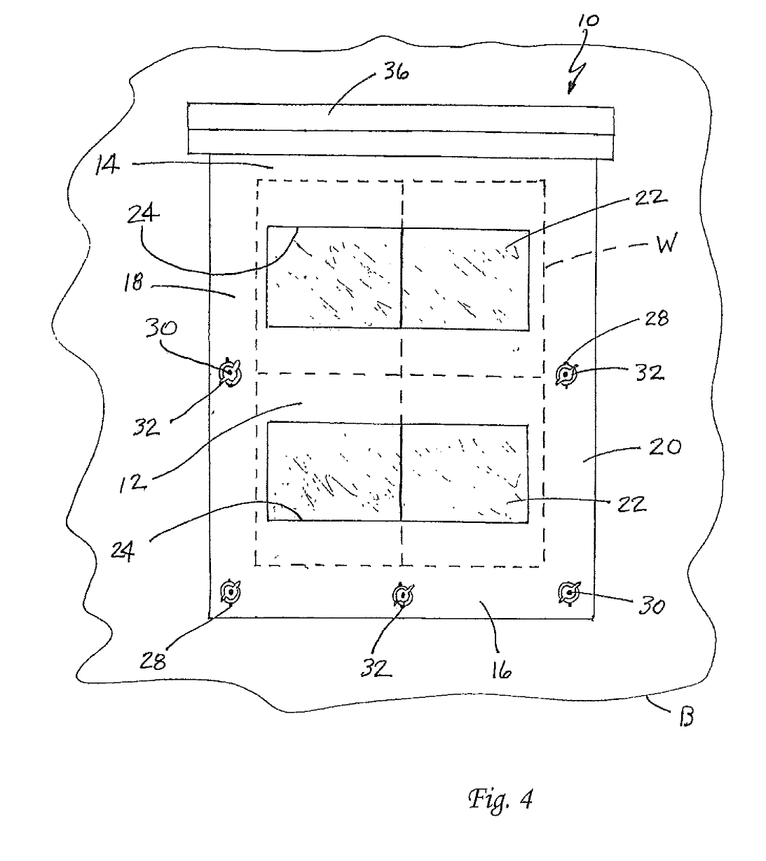

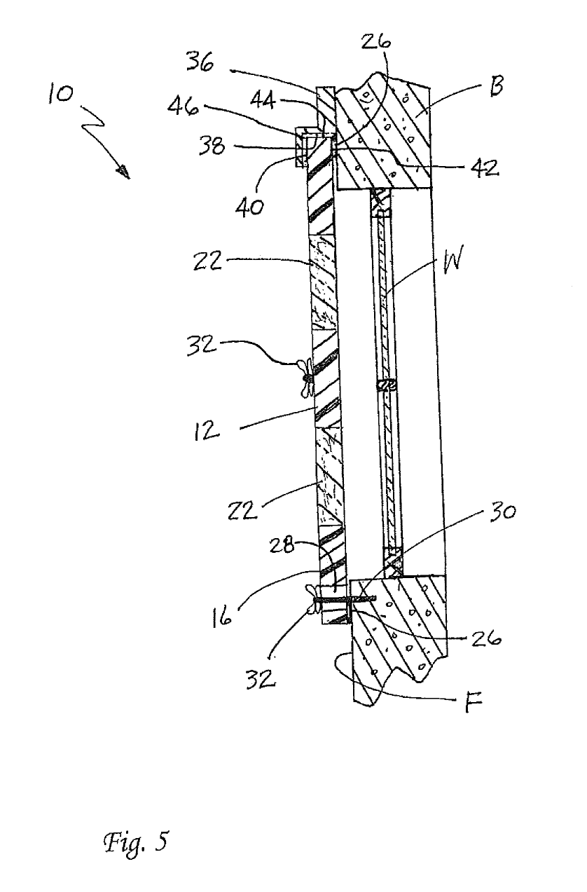

An alternative embodiment of the storm-shutter assembly 10 of the present invention is illustrated in FIGS. 4 and 5. In this embodiment the storm-shutter assembly 10 further includes a first mounting bracket 36 that has a cavity or pocket forming a receiver 38. The mounting bracket 36 is semi-permanently or permanently secured to the façade F of the building B by any appropriate means such as a fastener. Typically the mounting bracket 36 takes the form of a decorative hood positioned over the top of a window W.

In this second embodiment, the first or top-side 14 of the panel 12 includes a front margin 40, a rear margin 42 and a first or top edge 44 extending between the front and rear margins 40, 42. A first section 46 of the seal 26 covers the front margin 40, rear margin 42 and edge 44.

The panel 12 is mounted on the building B over the window W by first inserting the first or top side 14 snugly in the receiver 38 formed by the first mounting bracket 36 against the façade F of the building B. As the oblong or elongated apertures 28 along the second, third and fourth sides 16, 18, 20 of the panel 12 become aligned with the threaded anchors 30, the panel 12 is pivoted toward the façade F so that the threaded anchors 30 extend through the apertures 28. The wing nuts 32 are then tightened on the threaded anchors 30 so that the seal 26 seals against the façade F of the building B. A double seal is provided at the top of the window W between the seal 26 and the first mounting bracket 36 as well as between the seal 26 and the façade F of the building B.

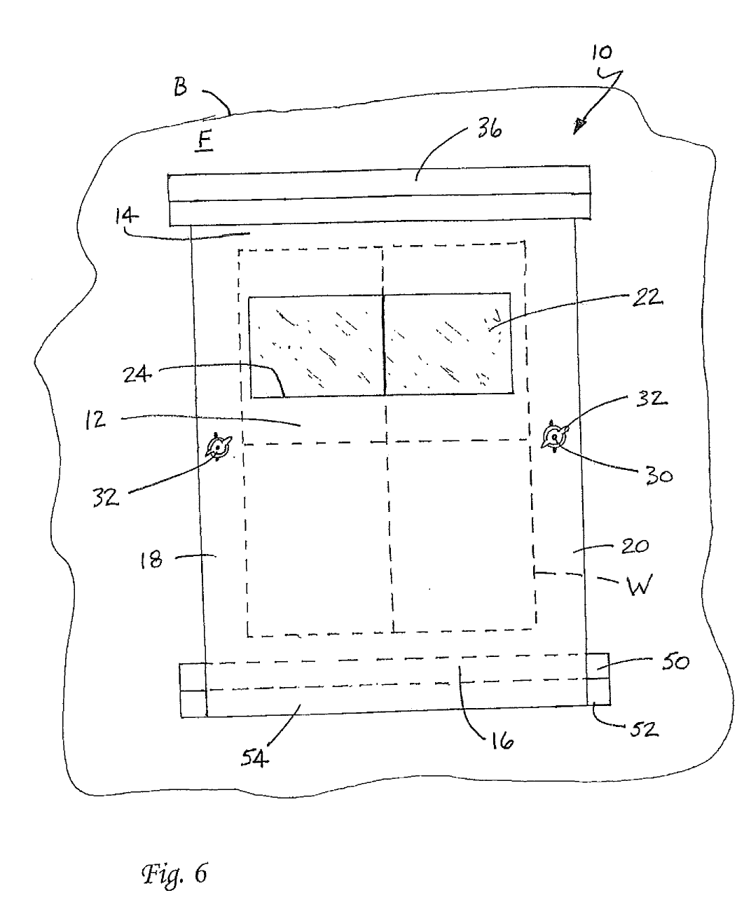

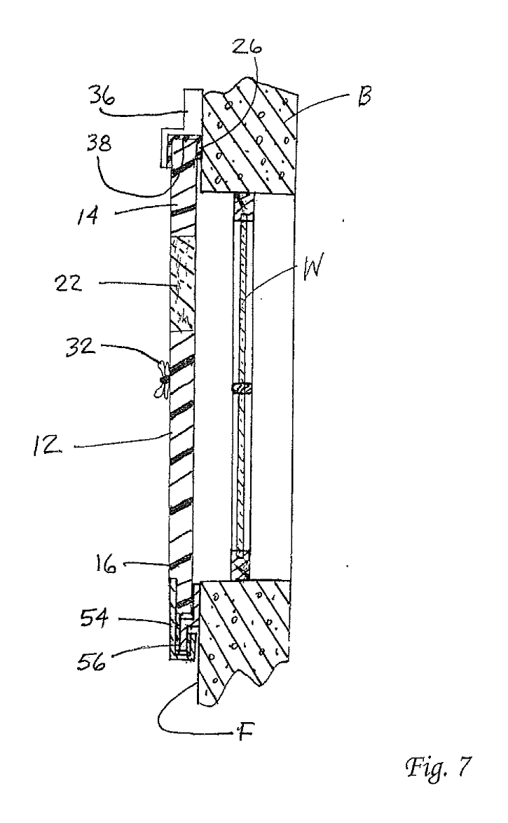

Still another embodiment is illustrated in FIGS. 6 and 7. This additional alternative embodiment includes the first mounting bracket 36 described above as well as a second mounting bracket 50. The second mounting bracket 50 includes a first mounting flange 52 and is semi-permanently or permanently secured to the façade F of the building B below the window W by any appropriate means. In this embodiment of the invention, the second or bottom side 16 of the panel 12 incorporates a second mounting flange 54 in the form of a hook. A second section 56 of the seal 26 is provided over the mounting flange or hook 54.

The panel 12 is mounted to the first and second mounting brackets 36, 50 by inserting the first or top side 14 of the panel 12 in the receiver 38 of the first mounting bracket 36 while simultaneously hooking the second mounting flange over the first mounting flange 52. At the same time, threaded anchors 30 projecting from the façade F of the building B along the sides of the window W are guided into the elongated apertures 28 provided in the second and third sides 16, 18 of the panel 12. When properly seated, the first section 46 of the seat 26 is sealing against the façade F and the first mounting bracket 36. Additionally, the second section 56 of the seal 26 is sealing between the first and second mounting flanges 52, 54. As the wing nuts 32 are tightened down on the threaded anchors 30, the seal 26 tightly seals against the façade F along the sides of the window W thereby protecting the window W from moisture and precipitation.

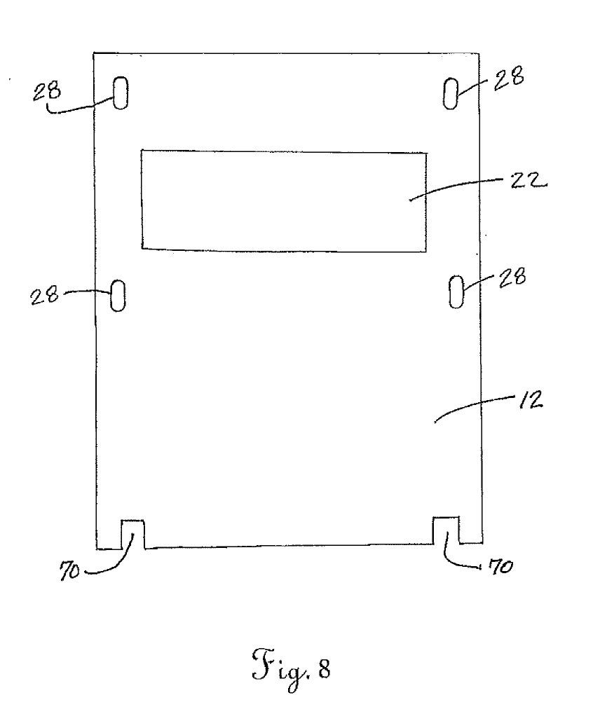

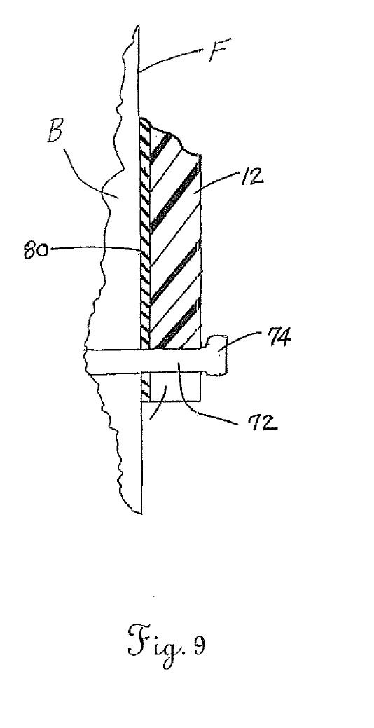

FIGS. 8 and 9 illustrate yet another embodiment of the storm shutter assembly 10 of the present invention. In this embodiment, the panel 12 includes two slots 70 along the bottom wall. When the shutter assembly 10 is mounted against the façade F on a building B, the panel 12 is positioned so that the slots 70 are received over and rest on stud-head mounting bolts 72. The heads 74 on the bolts 72 retain the panel 12 with the seal 80 against the façade F and prevent it from slipping off. Wing nuts 32 are secured on threaded anchors 30 that extend through the apertures 28 at the side and top of the panel 12 in the manner described above to complete the mounting. While straight slots 70 are illustrated in FIGS. 8 and 9 it should be appreciated that the slots could assume other appropriate shapes. Other shapes include but are not limited to J-shaped, L-shaped and Z-shaped.

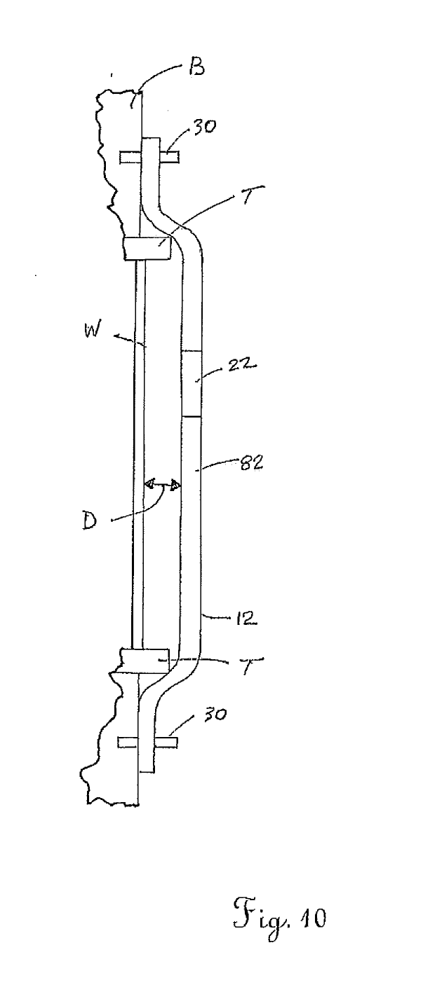

FIG. 10 discloses yet another embodiment of the storm shutter assembly 10. In this embodiment, the panel 12 has a convex shape so that the middle 82 of the panel is spaced a distance D from the wall W of the building B to which it is mounted. This allows the panel 12 to project around projecting trim T or other structures surrounding the window W. It also provides a larger clearance space between the panel 12 and the window W.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, the anchor bolts 30 and wing nuts 32 may be replaced by threaded mounting sockets in the building façade and cooperating bolts secured in the sockets through the apertures 28 in the panel 12. In yet another example, the threaded anchors 30 and the wing nuts 32 may be replaced with a fastener of alternative design such as any type of “quick disconnect” fastening system of a type known in the art and useful for the intended purpose. Such systems include, but are not limited to, ¼-½ turn fasteners and pull and lock-in (spring loaded) type anchors.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A storm-shutter assembly, comprising:
a panel including an opening;
a window held in said opening; and
a seal provided along a perimeter of said panel.

2. The storm-shutter assembly of claim 1, wherein said panel is constructed from a fiber reinforced plastic.

3. The storm-shutter assembly of claim 1, wherein said panel is constructed from a composite material including (a) a matrix binder selected from a group consisting of polyester, vinyl ester, epoxy, polyurethane, polycarbonate, polyamide, polypropylene, polyvinyl chloride and mixtures thereof and (b) a reinforcement element selected from a group consisting of glass fibers, carbon fibers, aramid fibers, polypropylene fibers, natural fibers and mixtures thereof.

4. The storm-shutter assembly of claim 3, wherein said window is made from a translucent, shatterproof material.

5. The storm-shutter assembly of claim 3, wherein said window is made from a transparent, shatterproof material.

6. The storm-shutter assembly of claim 3, wherein said window is made from a material selected from a group consisting of polycarbonate, reinforced polysulfone, glass reinforced polysulfone, glass reinforced polyester, glass reinforced epoxy, safety glass, bullet proof glass, glass and mixtures thereof.

7. The storm-shutter assembly of claim 6, wherein said seal is made from a material selected from a group consisting of rubber, silicone, plastic, vinyl, foam and mixtures thereof.

8. The storm-shutter assembly of claim 1, further including at least one fastener to secure said assembly to a building over a window to be protected.

9. The storm-shutter assembly of claim 8, wherein said at least one fastener is a wing nut.

10. The storm-shutter assembly of claim 1, wherein said assembly further includes a first mounting bracket that is secured to a building and defines a receiver for holding a first side of said panel.

11. The storm-shutter assembly of claim 10, wherein (a) said first side includes a first front margin, a first rear margin and a first edge extending between said first front margin and said first rear margin, (b) said seal includes a first section that covers said first front margin, said first rear margin and first edge and (c) said first section of said seal is received and held in said receiver.

12. The storm-shutter assembly of claim 11, wherein said panel includes a second side, a third side and a fourth side and a series of fasteners are provided along said second side, said third side and said fourth side to secure said panel to said building with said seal tightly engaging said building.

13. The storm-shutter assembly of claim 11, wherein said assembly further includes a second mounting bracket that is secured to said building and defines a first mounting flange for holding a second side of said panel.

14. The storm-shutter assembly of claim 13, wherein said second side is opposite said first side.

15. The storm-shutter assembly of claim 14, wherein said second side of said panel includes a second mounting flange that mates with said first mounting flange.

16. The storm-shutter assembly of claim 15, wherein said panel includes a third side and a fourth side and a series of fasteners are provided along said third side and said fourth side to secure said panel to said building with said seal tightly engaging said building.

17. The storm-shutter assembly of claim 16, wherein said seal includes a second section provided along said second mounting flange that engages and seals against said first mounting flange.
